(19) United States
(12) Patent Application Publication
(10) Pub. No.: US 2025/0285401 A1
(43) Pub. Date: Sep. 11, 2025

(54) IMAGE PROCESSING DEVICE, COMPUTER PROGRAM PRODUCT, AND IMAGE PROCESSING METHOD

(71) Applicant: KABUSHIKI KAISHA TOSHIBA, Tokyo (JP)

(72) Inventors: Gaku MINAMOTO, Kawasaki Kanagawa (JP); Satoshi ITO, Kawasaki Kanagawa (JP); Reiko NODA, Kawasaki Kanagawa (JP)

(73) Assignee: KABUSHIKI KAISHA TOSHIBA, Tokyo (JP)

(21) Appl. No.: 19/061,720

(22) Filed: Feb. 24, 2025

(30) Foreign Application Priority Data
Mar. 8, 2024 (JP) 2024-036197

(51) Int. Cl. G06V 10/25; G06V 10/764; G06V 10/774; G06V 10/82; G06V 20/56

(52) U.S. Cl. CPC G06V 10/25; G06V 10/764; G06V 10/774; G06V 10/82; G06V 20/588

(57) ABSTRACT

According to an embodiment, an image processing device includes a memory and one or more processors coupled to the memory. The one or more processors are configured to: generate attention information for performing region detection of a detection target based on detection information related to the detection target, the detection target being detected from an image by using a first inference model; perform the region detection by using a second inference model based on the attention information and the image from which the detection target is detected; and output at least one of the image, the detection information, the attention information, and a result of the region detection.

### CROSS-REFERENCE TO RELATED APPLICATIONS

This application is based upon and claims the benefit of priority from Japanese Patent Application No. 2024-036197, filed on Mar. 8, 2024; the entire contents of which are incorporated herein by reference.

### FIELD

Embodiments of the present invention relate generally to an image processing device, a computer program product, and an image processing method.

### BACKGROUND

In recent years, automation of infrastructure inspection of roads, electric power devices, and the like has been advanced. As automation of inspection, a technique for detecting defect (damage or abnormal state) of an inspection target from an image has been developed.

For example, there is a road surface defect detection technique for detecting defect of a road surface from a camera image. Specifically, in order to reduce the labor of the annotation work, weakly supervised learning is used to train a machine learning model using only information about the presence or absence of defect in images, and the learned model is used to detect defect locations within the images.

In addition, a technique of photographing a road surface with a camera and detecting the presence or absence of damage of the road surface by using a learned model is known. Specifically, for the problem that detection accuracy deteriorates because the state of the image is different depending on the photographing time zone, the detection accuracy is improved by reevaluating the presence or absence of defect by using a plurality of images of different photographing dates and times at the same photographing place.

However, in the conventional technique, the presence or absence of defect within the image can be detected, but there is a problem that a defect region within the image is unclear. In addition, the presence or absence of damage is reevaluated, but the detection accuracy of the damaged region within the image cannot be improved.

### BRIEF DESCRIPTION OF THE DRAWINGS

FIG. 1 is a diagram illustrating an example of a road surface defect detection system 1 according to an embodiment;

FIG. 2 is a functional block diagram of an example of a road surface defect detection system 1 according to the embodiment;

FIG. 3 is a diagram illustrating an example of training data in weakly supervised learning according to the embodiment;

FIGS. 4A and 4B are diagrams explaining Multiple Instance Learning with respect to an image;

FIG. 5 is a diagram illustrating an example of a learning method of a first inference model according to the embodiment;

FIGS. 6A and 6B are diagrams illustrating an example of an attention information generation module according to the embodiment;

FIG. 7 is a diagram illustrating an example of expressing a plurality of types of normal regions according to the embodiment;

FIG. 8 is a diagram illustrating an example of a screen on which a user inputs generated text;

FIG. 9 is a diagram illustrating an example of a screen on which a user selects a language model to use for text generation;

FIG. 10 is a diagram illustrating an example of processing of a region detection module according to the embodiment;

FIG. 11 is a diagram illustrating an example of a detection result display screen according to the embodiment;

FIG. 12 is a flowchart illustrating an example of image processing executed by the image processing device according to the embodiment;

FIG. 13 is a diagram illustrating an example of target points generated by an attention information generation module according to a second embodiment;

FIG. 14 is a diagram illustrating an example of an attention information selection screen according to the embodiment;

FIG. 15 is a diagram illustrating an example of a detection result display screen according to the second embodiment; and

FIG. 16 is a diagram illustrating an example of a display screen according to the embodiment.

### DETAILED DESCRIPTION

In general, according to one embodiment, an image processing device includes a memory and one or more processors coupled to the memory. The one or more processors are configured to: generate attention information for performing region detection of a detection target based on detection information related to the detection target, the detection target being detected from an image by using a first inference model; perform the region detection by using a second inference model based on the attention information and the image from which the detection target is detected; and output at least one of the image, the detection information, the attention information, and a result of the region detection.

Exemplary embodiment of an image processing device, a computer program product, and an image processing method will be explained below in detail with reference to the accompanying drawings. The present invention is not limited to the following embodiments.

### First Embodiment

In a first embodiment, a road surface defect detection system 1 that detects an expressway as an inspection target and detects a defect of a road surface as a detection target will be described by way of an example. However, the inspection target and the detection target are not limited thereto.

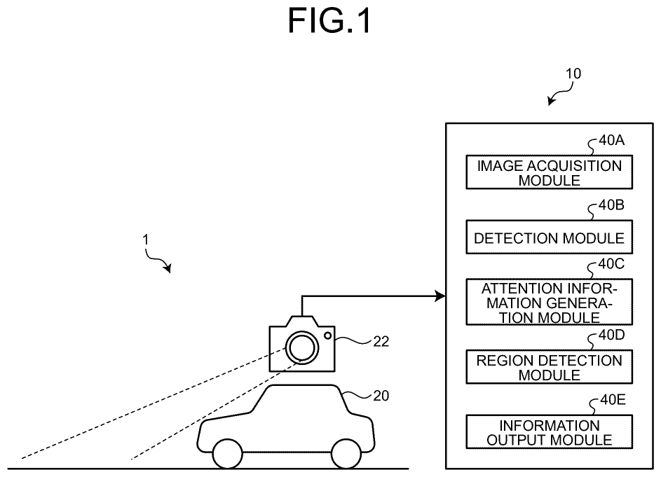

FIG. 1 is a diagram illustrating an example of a road surface defect detection system 1 according to a first embodiment. The road surface defect detection system 1 uses an image processing device 10 and a moving body 20 as an example. The image processing device 10 and the moving body 20 are communicably connected in a wireless or wired manner.

The image processing device 10 is an example of an image processing device of the present embodiment. The image processing device 10 is an image processing device that detects a road surface defect from the imaged image. The image processing device 10 may be provided inside the moving body 20 described later.

The moving body 20 is, for example, a moving body used to collect an imaged image in the road surface defect detection system 1. The moving body 20 includes an imaging device 22, and transmits the imaged road surface image to the image processing device 10. The moving body 20 merely needs to be movable to image at least an image of a detection target. Examples thereof include a robot having a position moving mechanism, an automobile, a ship, and a flying object. The moving body 20 may move autonomously or may be moved by operation of the user.

Note that the imaging device 22 may not be provided in the moving body 20. For example, a camera that can be carried by a user may be used. In the first embodiment, an example in which the imaging device 22 is provided in the moving body 20 will be described.

In the first embodiment, a mode in which the moving body 20 is an automobile that moves by operation of a user will be described by way of an example. For example, the moving body 20 is an inspection vehicle driven by a user who inspects an expressway. The inspection vehicle routinely inspects whether there is an abnormality in a road surface of the expressway and an accessory of the expressway. Furthermore, the moving body 20 includes a camera as the imaging device 22.

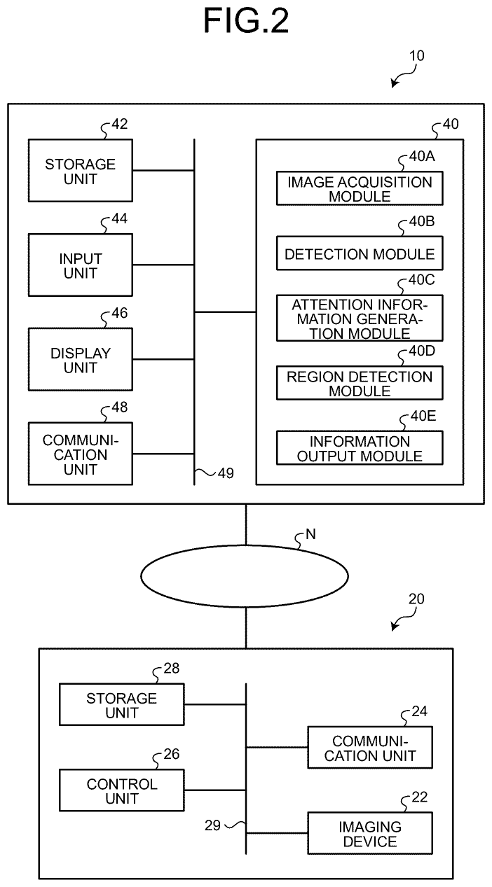

FIG. 2 is a functional block diagram of an example of the road surface defect detection system 1. The road surface defect detection system 1 includes an image processing device 10 and a moving body 20. The image processing device 10 and the moving body 20 are communicably connected via a network N or the like.

The moving body 20 includes an imaging device 22, a communication unit 24, a control unit 26, and a storage unit 28. The imaging device 22, the communication unit 24, the control unit 26, and the storage unit 28 are communicably connected via a bus 29 or the like.

The imaging device 22 images an inspection target in the moving body 20. For example, the imaging device 22 is a camera, a smartphone, or the like. The imaging device 22 merely needs to be able to image the inspection target, and the arrangement position and the arrangement number are not limited. For example, the imaging device 22 may be arranged at each of the front, the side, and the rear of the inspection vehicle. Furthermore, the imaging device 22 may be arranged inside and outside the inspection vehicle. It may not be provided in the vehicle.

The control unit 26 transmits the imaging result of the imaging device 22 from the communication unit 24 to the image processing device 10. In the first embodiment, the control unit 26 transmits the imaging result of the imaging device 22 to the image processing device 10 every predetermined time. That is, the control unit 26 of the moving body 20 sequentially transmits the photographing results continuous in time series to the image processing device 10. Furthermore, the control unit 26 may temporarily transmit the imaging result to the storage unit 28 and store the imaging result. In this case, the control unit 26 may collectively transmit the imaging results stored in the storage unit 28 to the image processing device 10 regardless of the time series.

The storage unit 28 stores various types of data. The storage unit 28 is, for example, a semiconductor memory element such as a random access memory (RAM) or a flash memory (registered trademark), a hard disk, an optical disk, or the like.

Next, the image processing device 10 includes an image processing unit 40, a storage unit 42, an input unit 44, a display unit 46, and a communication unit 48. The image processing unit 40, the storage unit 42, the input unit 44, the display unit 46, and the communication unit 48 are communicably connected via a bus 49 or the like.

First, the storage unit 42 stores various types of data. The storage unit 42 is, for example, a semiconductor memory element such as a RAM or a flash memory, a hard disk, an optical disk, or the like. Note that the storage unit 42 may be a storage device provided outside the image processing device 10. Furthermore, the storage unit 42 may be a storage medium in which programs and various types of information are downloaded via a local area network (LAN), the Internet, or the like and stored or temporarily stored.

The input unit 44 accepts various operations by the user. The input unit 44 is, for example, a pointing device such as a keyboard and a mouse, a microphone, or the like.

The display unit 46 displays various types of information. The display unit 46 displays, for example, an imaged image transmitted from the imaging device 22, an image processing result by the image processing unit 40, and the like. Note that the display unit 46 may be configured integrally with the input unit 44 and configured as a touch panel.

Furthermore, the input unit 44 and the display unit 46 may be configured as separate bodies from the image processing device 10. In this case, the input unit 44 and the display unit 46 may be communicably connected with the image processing device 10.

The communication unit 48 is, for example, a communication interface capable of communicating with the moving body 20 and the imaging device 22 via the network N or the like.

At least one of the storage unit 42 and the image processing unit 40 may be mounted on an external information processing device such as a server device connected via the network N and the communication unit 48.

Furthermore, at least one of functional units described later included in the image processing unit 40 may be mounted on an external information processing apparatus such as a server device connected to the image processing unit 40 via the network N and the communication unit 48.

The image processing unit 40 executes various types of image processing in the image processing device 10. The image processing unit 40 includes an image acquisition module 40A, a detection module 40B, an attention information generation module 40C, a region detection module 40D, and an information output module 40E.

The image acquisition module 40A, the detection module 40B, the attention information generation module 40C, the region detection module 40D, and the information output module 40E are realized by one or a plurality of processors. For example, each of the above units may be realized by causing a processor such as a central processing unit (CPU) to execute a program, that is, by software. Each of the above units may be realized by a processor such as a dedicated IC, that is, hardware. Each of the above units may be realized by using software and hardware in combination. When a plurality of processors are used, each processor may realize one of the units or may realize two or more of the units.

The image acquisition module 40A acquires an imaged image of an inspection target. For example, while the moving body 20 is traveling on an expressway of the inspection target, an image imaged by the imaging device 22 is acquired. Note that the image acquisition module 40A may acquire at least one frame image as the image of a processing target from the road surface video generated by the imaging device 22. Furthermore, the image acquisition module 40A may be configured to acquire the imaged image by accessing a database of the video acquired by the imaging device 22. In addition, for example, the imaged image may be acquired from a portable storage medium such as a memory card.

The detection module 40B executes detection processing of a detection target on the imaged image acquired by the image acquisition module 40A. For example, the detection module 40B detects defect of a road surface with respect to the image of the road surface acquired by the image acquisition module 40A. When defect of a road surface is detected with respect to an image, defect information related to the defect is output. Alternatively, it may be held in the storage unit 42 once.

The defect is an abnormality that appears in the inspection object. For example, the defect of the road surface is a crack, rattle, pothole, depression, dent, step, or the like formed on the road surface. The defect may define a degree of severity according to its size, depth, and the like. For example, for the pothole, the degree of severity may be defined as AA or A according to the size or depth thereof.

Furthermore, the detection module 40B outputs defect information. The defect information is information related to defect. For example, the detection module 40B outputs defect type as the defect information. For example, when a pothole is detected on the road surface appearing in the imaged image, the detection module 40B outputs “pothole” as the defect type. In addition, the detection module 40B may output “AA: pothole” to which the degree of severity is added as the defect type.

Furthermore, the detection module 40B may output a likelihood map as defect information. The likelihood map is a score map representing the defect likelihood at each position in the image. For example, the lengths of the vertical and horizontal directions of the likelihood map are the same as those of the input image. For example, the score takes a continuous value from 0 to 1, and the larger the value, the more likely the specific defect is. Which position in the input image likely to have defect can be visualized by the likelihood map.

In addition, as the defect information, a binary value obtained by setting the value of the likelihood map greater than or equal to a predetermined threshold value to 1 and setting the other values to 0 may be output. Alternatively, the predetermined threshold value may be input by the user or may be set to a fixed value in advance. Different predetermined threshold values may be set for each type of defect.

In the first embodiment, an example in which a defect type is output as defect information will be described. The detection module 40B executes detection processing on the imaged image acquired by the image acquisition module 40A using a first inference model.

The first inference model may be a rule-based inference model or may be built by machine learning. For example, the first inference model is a neural network. For example, the first inference model is a neural network learned by supervised learning.

The first inference model may be, for example, a method of calculating a likelihood map of the input image based on a difference in feature amounts when each of the input image and the normal image is input to a neural network learned in advance with a large amount of images. Here, the normal image is an image illustrating a normal state of the inspection target. The neural network learned in advance may be, for example, a neural network learned using an ImageNet data set which is a technology described below. Herein, ImageNet: A large-scale hierarchical image database, CVPR 2009, pp. 248-255 (2009), J. Deng et al.

In addition, for example, a normal image similar to the input image is searched from the normal image group collected in advance to be used as a reference image, a difference in feature amounts obtained from the learned neural network between the input image and the reference image is calculated, and the likelihood map is calculated. For example, the technology described below can be used: Sub-Image Anomaly Detection with Deep Pyramid Correspondences, arXiv: 2005. 02357 (2020), N. Cohen and Y. Hoshen.

In addition, similarly to the above, the difference in the feature amount between the input image and the reference image is calculated to calculate the likelihood map, but for example, in the technology described below, the difference in the feature amount between the reference images is further calculated to calculate a normal image fluctuation map. The normal image fluctuation map is a score map indicating the variation of the normal pattern at each position of the image. The likelihood map is corrected by the normal image fluctuation map. For example, the technology described below can be used: Unsupervised Anomaly Localization Using Locally Adaptive Query-Dependent Scores, ICIAP 2022 (LNCS, vol. 13232), pp. 300-311 (2022), N. Kawamura.

Furthermore, for example, a learning data set obtained by combining an image of a road and a circumscribed rectangle indicating a defect position appearing in the input image as a training label may be prepared, and the first inference model may be learned.

However, the annotation work takes time when preparing the circumscribed rectangle indicating the defect position as the training label. In addition, there is a problem that individual differences occur in the determination of the defect portion depending on the annotation worker.

Therefore, in the learning of the first inference model, weakly supervised learning in which only an image and the presence or absence of defect appearing in the image are combined as the training label may be used. As a specific example, the first inference model is trained by weakly supervised learning using data in which the presence or absence of a plurality of types of defect is given to an image by a multi-label of 0 or 1.

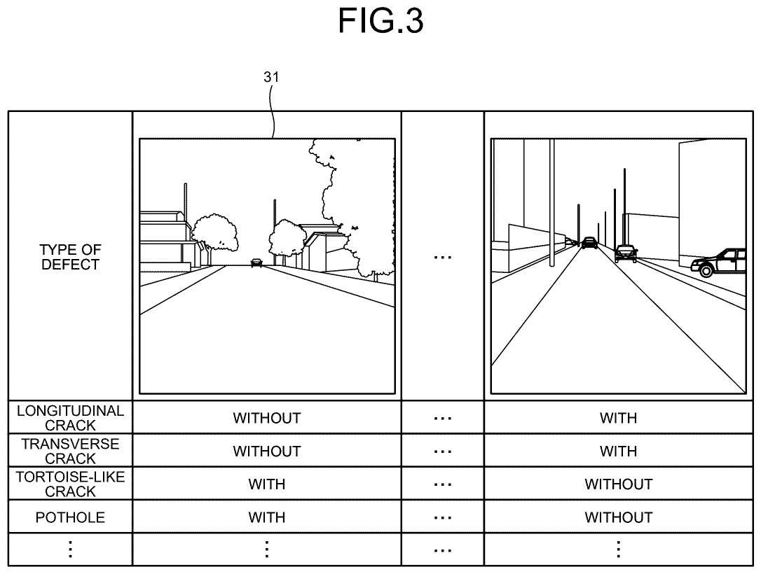

FIG. 3 illustrates an example of training data consisting of an image and a training label in the weakly supervised learning. For example, a road surface image 31 of FIG. 3 indicates that “longitudinal cracks and transverse cracks are not included, but tortoise-like cracks and potholes are included”. In this case, the specific locations of defects in the road surface image 31 are not illustrated. The framework of Multiple Instance Learning can be applied to the setting in which only the image and the presence or absence of defect appearing in the image are used as the training label.

Multiple Instance Learning is one of supervised learning. In general supervised learning, a label y is given to each sample x. On the other hand, in the Multiple Instance Learning, a correct answer label is given to a set obtained by collecting a plurality of instances. In Multiple Instance Learning, this set is called a bag. For example, a correct answer label in the case of the two-class identification task will be described. With a case where all instances in the bag are negative example instances as a negative example, a label y=0 is given, and with a case where there is at least one positive example instance in the bag as a positive example, a positive example label y=1 is given.

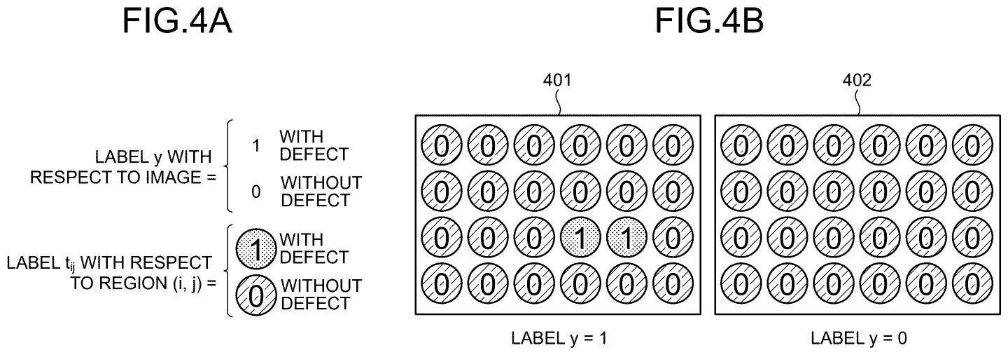

FIGS. 4A and 4B are diagrams illustrating Multiple Instance Learning for an image. Consider a case where the defect type of the detection target is only one type. When defect detection for a road image is interpreted as Multiple Instance Learning, each region (i, j) in the image corresponds to an instance. Here, i is an index indicating a position in the horizontal direction in the image, and j is an index indicating a position in the horizontal direction in the image. For example, each region (i, j) may be in units of pixels or in units of patches obtained by dividing an image. In addition, an image corresponds to the set bag in which the instances are collected.

FIGS. 4A and 4B illustrate a relationship between the label t_ij for each region (i, j) in the image and the label y for the image. Here, 1 represents with defect, and 0 represents without defect. A label y=1 of with defect is given to an image 401 including at least one region with defect, and a label y=0 of without defect is given to an image 402 in which all the regions have no defect. That is, as illustrated in Equation (1), a relationship is established in which the maximum value of the label t_ij for the region is equal to the label y for the image.

$$y = {max}_{ij} {t}_{ij} \qquad ( 1 )$$

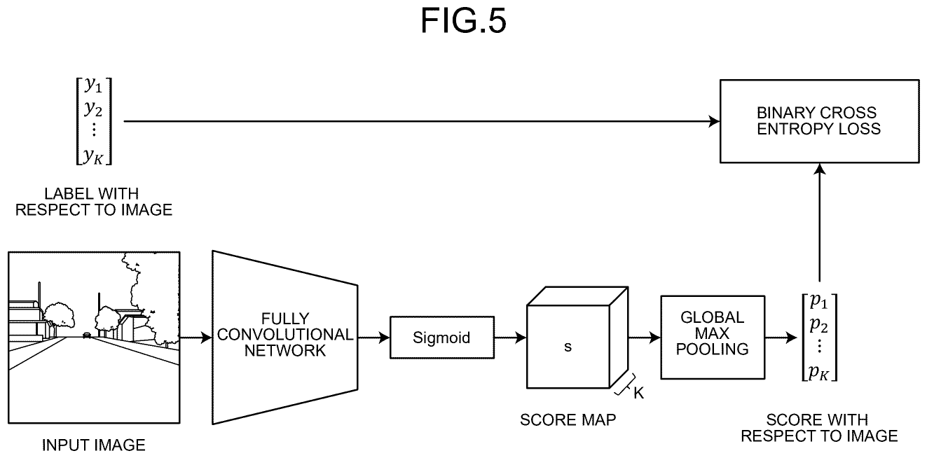

FIG. 5 illustrates an example of a learning method of the first inference model. An example of a method of learning the first inference model by Multiple Instance Learning will be described. For example, the first inference model is configured by a Fully Convolutional Network configured by a convolution operation having locality in a spatial direction. A score s_ij representing the defect likelihood of each region (i, j) in the image is calculated using the first inference model. Here, s_ij is a continuous value from 0 to 1, and the larger s_ij is, the more likely the defect is. The score s_ij is calculated with respect to all the regions in the image using the first inference model, and the maximum value thereof is set as the score p with respect to the image. The score p is expressed as in Equation (2). In FIG. 5, K indicates the number of types of defect. That is, it corresponds to the number of score maps to be calculated. In a case where the defect type of the detection target is one type, K=1.

$$p = {max}_{ij} {s}_{ij} \qquad ( 2 )$$

Using the score p with respect to the image and the label y with respect to the image, Binary Cross Entropy Loss is calculated, and the first inference model is optimized to minimize this loss. The Binary Cross Entropy Loss (L) is expressed by Equation (3).

$$L = - y log p - ( 1 - y ) log ( 1 - p ) \qquad ( 3 )$$

According to this learning method, the first inference model can be learned so that the score s_ij with respect to the region is low for a region without defect and high for a region with defect. Although the case where there is one type of defect has been described above, in a case where there are a plurality of types, the score map may be calculated only for the type of defect. In the first embodiment, Global Max Pooling is used for conversion from the score map to the score with respect to the image.

That is, the first inference model learns from training data that has information about the presence or absence of defect of a specific detection target in a predetermined unit with respect to an image, outputs likelihood in a unit smaller than the predetermined unit, and performs learning such that the maximum value of the output likelihood matches the annotated label presence or absence of defect of the detection target.

Returning to FIG. 2, the attention information generation module 40C calculates attention information for detecting a defect region based on defect information of an image in which defect is detected. The attention information is transmitted to the region detection module 40D and used for defect region detection. For example, the attention information is a text representing defect based on the defect type or a text representing a normal region corresponding to the defect type. Note that the normal region is a background region by way of an example. Furthermore, the attention information may be position information based on a likelihood map. Furthermore, the attention information generation module 40C may generate at least one of a text representing defect based on the defect type and a text representing a normal region corresponding to the defect type.

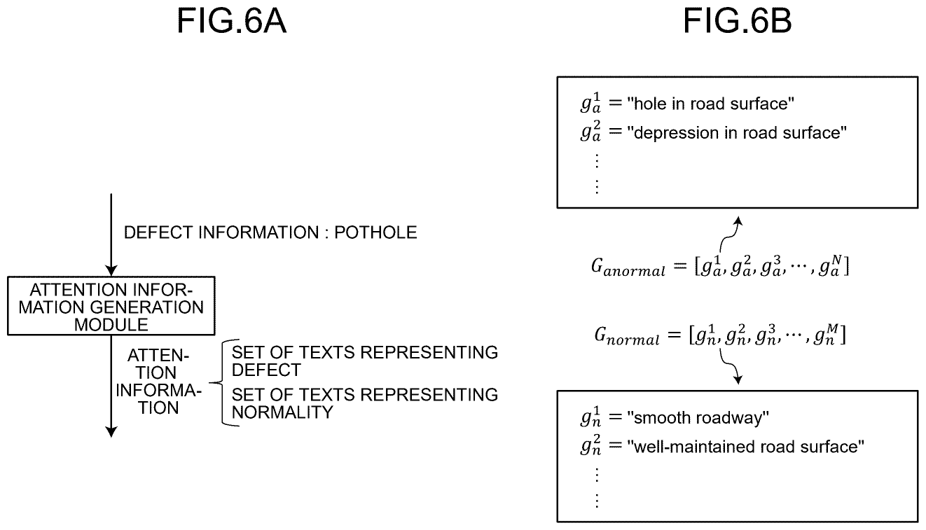

Next, the attention information generation module 40C according to the first embodiment will be described with reference to FIGS. 6A and 6B. In the first embodiment, the attention information generation module 40C receives the defect type as the defect information from the detection module 40B, and generates a text representing defect based on the defect type. In addition, in the first embodiment, the attention information generation module 40C generates a text representing a surrounding normal region related to the defect type in addition to the text representing the defect.

The attention information generation module 40C generates at least one text representing defect and at least one text representing a normal region based on the defect type. Note that a plurality of texts may be generated. For example, a set of texts representing defect generated by the attention information generation module 40C is assumed as Gₐₙₒᵣₘₐₗ. Gₐₙₒᵣₘₐₗ has N text representing defects as an element.

Gₐₙₒᵣₘₐₗ=[g¹ₐ,g²ₐ,g³ₐ, . . . ,g^{N}ₐ]

Here, g¹ₐ is one text representing defect. For example, in a case where a pothole is received as the defect type, the attention information generation module 40C generates a text g¹ₐ representing the pothole as follows. After g³ₐ, text is similarly generated.
g¹ₐ=“a hole in a road surface”
g²ₐ=“a depression in a road surface”

In addition, a set of texts representing a surrounding normal region related to the defect type is Gₙₒᵣₘₐₗ. Gₙₒᵣₘₐₗ has M texts as elements that represent surrounding normal regions related to the defect type.

Gₙₒᵣₘₐₗ=[g¹ₙ,g²ₙ,g³ₙ, . . . ,g^{M}ₙ]

Here, g¹ₙ is one text representing a surrounding normal region related to the defect type. For example, in a case where a pothole is received as the defect type, the attention information generation module 40C generates a text gⁱₙ representing a normal region related to the pothole as follows. After g³ₙ, text is similarly generated.
g¹ₙ=“smooth roadway”
g²ₙ=“well-maintained road surface”

Then, the attention information generation module 40C transmits the above-described Gₐₙₒᵣₘₐₗ and Gₙₒᵣₘₐₗ to the region detection module 40D as attention information. Furthermore, the attention information generation module 40C may generate text representing a plurality of types of normal regions.

In addition, the detection information includes a defect type of the detection target, and the attention information generation module 40C generates, as the attention information, a text representing defect characterizing at least one specific detection target and a text representing normality characterizing a background region related to at least one specific detection target based on the defect type of the detection target.

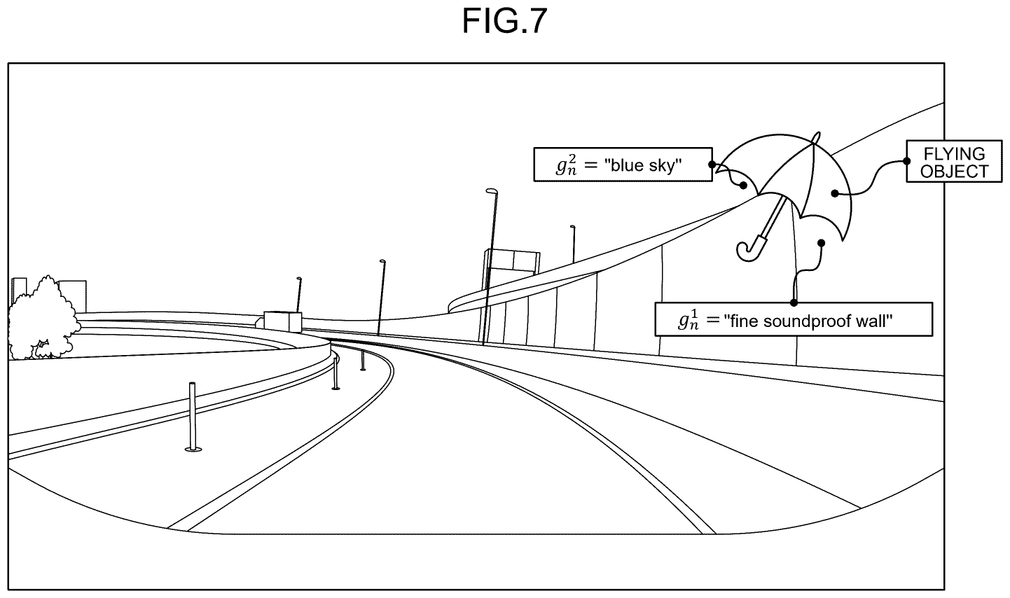

An example of text representing a plurality of types of normal regions will be described with reference to FIG. 7. For example, a sound insulation wall in which an inspection target is an expressway accessory is considered as an example. For example, consider a case where a flying object attached to the sound insulation wall is detected as defect. The detection module 40B transmits “flying object” as the defect type. For example, when a flying object attached to the upper part of the sound insulation wall, the related normal region includes “sky” in addition to “sound insulation wall”. In that case, the attention information generation module 40C may generate a text representing a normal sound insulation wall and a text representing sky. Specifically, the following may be performed. After g³ₙ, text is similarly generated.
g¹ₙ=“fine soundproof wall”
g²ₙ=“blue sky”

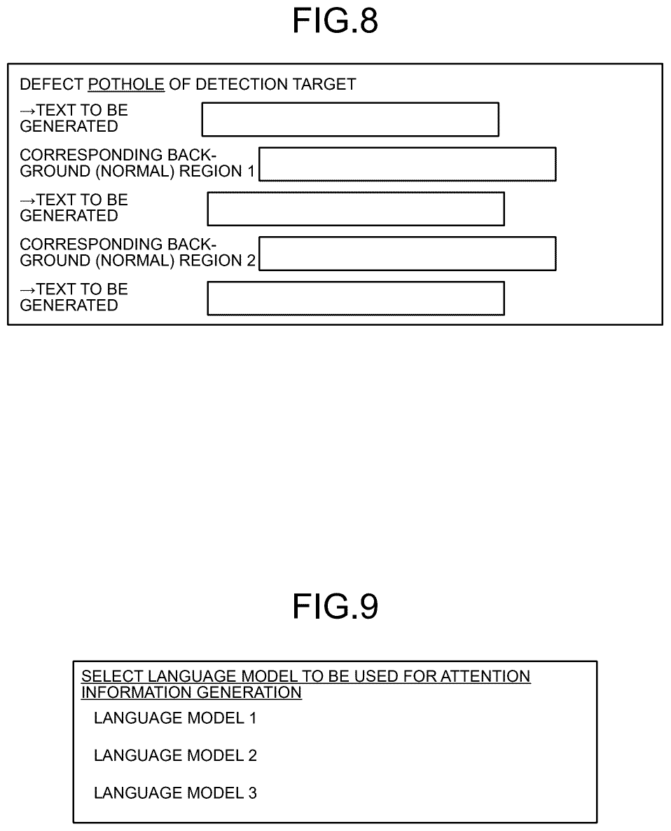

FIG. 8 is an example of a display screen on which the user inputs a generated text. The text to be generated may be set in advance by the user based on the inspection target. For example, in a case where the user sets in advance, the user inputs the corresponding text from the input unit. As illustrated in FIG. 8, for example, the information output module 40E displays a screen for inputting text generated by the user and a corresponding background region on the display unit 46.

FIG. 9 is an example of a display screen on which the user selects a language model to use for text generation. The text to be generated may be generated using a large-scale language model (LLM). In the case of using a large-scale language model (LLM), the attention information generation module 40C includes a learned large-scale language model, and generates text using the large-scale language model based on the defect type output by the detection module 40B.

For example, the attention information generation module 40C generates a plurality of texts by inputting “List a plurality of sentences expressing a pothole on the road surface” to the large-scale language model. Furthermore, the attention information generation module 40C may include a plurality of large-scale language models, and the user may select which large-scale language model to use to generate the text. In this case, for example, the information output module 40E displays a screen for inputting the large-scale language model selected by the user on the display unit 46.

That is, there may be a UI in which the user designates the LLM that generates the text. Furthermore, there may be a UI in which the user inputs a text. Note that the text input screen in FIG. 8 and the text generation method selection screen in FIG. 9 may be integrated.

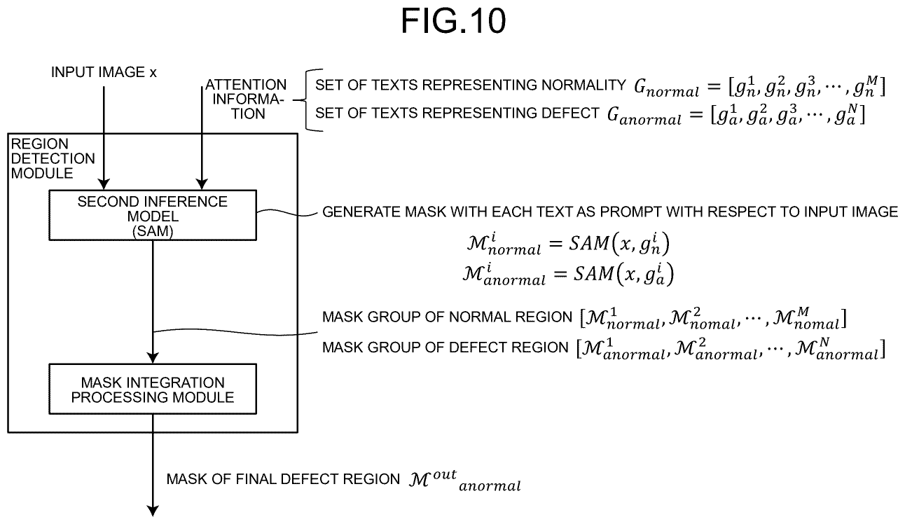

FIG. 10 illustrates an example of processing of the region detection module 40D in the first embodiment. With respect to the image in which the defect is detected by the detection module 40B, the region detection module 40D detects the defect region using the attention information generated by the attention information generation module 40C. That is, when defect is detected by the detection module 40B, the region detection module 40D receives an image in which defect is detected from the image acquisition module 40A, and performs detection of a defect region based on the attention information with respect to the image. In addition, the region detection module 40D performs region detection using the second inference model.

In addition, the attention information which is the defect information related to defect of the detection target and the normal information of the background region related to defect of the detection target is sent to the region detection module 40D. Then, the region detection module 40D performs the defect region detection by performing defect region detection of the detection target and normal region detection of the background region, and integrating the detection results.

The second inference model may be a rule-based inference model or may be built by machine learning. For example, the second inference model may be a learned semantic segmentation model. Semantic segmentation is a method of predicting to which class each pixel (pixel) belongs with respect to each pixel of an image.

In the first embodiment, an example in which a learned semantic segmentation model is used as the second inference model will be described. For example, a case where the following segment anything model (SAM) is used as the second inference model will be described.
SAM: Segment Anything|Meta AI (segment-anything.com)
<URL: https://segment-anything.com/>

The SAM is a foundation model for semantic segmentation. The SAM receives the prompt and the image, and performs semantic segmentation on the image. The prompts that can be input into the SAM are text, a target point, and a rectangle. The region detection module 40D uses the attention information generated by the attention information generation module 40C as a prompt to input to the SAM.

In the first embodiment, a set of Gₐₙₒᵣₘₐₗ and Gₙₒᵣₘₐₗ of the text generated as the attention information by the attention information generation module 40C is used as a prompt to input into the SAM. As described above, Gₐₙₒᵣₘₐₗ generated by the attention information generation module 40C has texts representing defect as elements. Gₙₒᵣₘₐₗ has, as elements, texts representing normal regions related to defect.

The region detection module 40D performs detection of a normal region and detection of a defect region on the input image using the elements gⁱ_{a′} of Gₐₙₒᵣₘₐₗ and the elements gⁱₙ of Gₙₒᵣₘₐₗ as prompts. For example, description will be made using the input image as x. The segmentation is performed on the input image x using the SAM with the text gⁱₐ representing the defect as a prompt. Then, assuming that the mask of the obtained defect region is Mⁱₐₙₒᵣₘₐₗ, it can be written as follows.

Mⁱₐₙₒᵣₘₐₗ=SAM(x,gⁱₐ)

Here, the mask indicates information indicating which pixel in the input image corresponds to the defect region. For example, the mask is an image having the same size as the input image, and 1 is assigned to the pixel detected as the defect region, and 0 is assigned to the other pixels.

Furthermore, for example, segmentation is performed on the input image x using the SAM with the text gin representing a normal region related to defect as a prompt. Then, assuming that the mask of the obtained normal region is Mⁱₙₒᵣₘₐₗ, it can be written as follows.

Mⁱₙₒᵣₘₐₗ=SAM(x,gⁱₙ)

Furthermore, a mask group of N defect regions obtained from N texts Gₐₙₒᵣₘₐₗ representing defect is represented as follows.

[M¹ₐₙₒᵣₘₐₗ,M²ₐₙₒᵣₘₐₗ, . . . ,M^{N}ₐₙₒᵣₘₐₗ]

Furthermore, a mask group of M normal regions obtained from M texts Gₙₒᵣₘₐₗ representing normality is represented as follows.

[M¹ₙₒᵣₘₐₗ,M²ₙₒᵣₘₐₗ, . . . ,M^{M}ₙₒᵣₘₐₗ]

The region detection module 40D integrates the mask group [M¹ₐₙₒᵣₘₐₗ, M²ₐₙₒᵣₘₐₗ, . . . , M^{N}ₐₙₒᵣₘₐₗ] of the defect region and the mask group [M¹ₙₒᵣₘₐₗ, M²ₙₒᵣₘₐₗ, . . . , M^{M}ₙₒᵣₘₐₗ] of the normal region to detect the defect region.

An example of a method of integrating the detection result of the defect region and the detection result of the normal region will be described. For example, first, the region detection module 40D generates the mask Mₐₙₒᵣₘₐₗ of one defect region from the mask group [M¹ₐₙₒᵣₘₐₗ, M²ₐₙₒᵣₘₐₗ, . . . , M^{N}ₐₙₒᵣₘₐₗ] of the defect region. For example, the region detection module 40D may select one mask from [M¹ₐₙₒᵣₘₐₗ, M²ₐₙₒᵣₘₐₗ, . . . , M^{N}ₐₙₒᵣₘₐₗ] according to a rule defined in advance, and set the mask as Mₐₙₒᵣₘₐₗ.

For example, a mask having the largest area may be selected from the mask group [M¹ₐₙₒᵣₘₐₗ, M²ₐₙₒᵣₘₐₗ, . . . , M^{N}ₐₙₒᵣₘₐₗ] of the defect region, and may be set as Mₐₙₒᵣₘₐₗ. In addition, the user may select and integrate an arbitrary number of masks from N masks. When the user designates a mask to use for integration, the user designates the mask to use for integration from the input unit. For example, the information output module 40E superimposes a mask on the input image and displays it on the display unit 46, and the user selects a mask to use for integration while viewing the display screen.

Furthermore, for example, an operation of obtaining a union or a product set may be performed with all the elements of [M¹ₐₙₒᵣₘₐₗ, M²ₐₙₒᵣₘₐₗ, . . . , M^{N}ₐₙₒᵣₘₐₗ]. For example, in the case of obtaining a union, Mₐₙₒᵣₘₐₗ can be expressed as follows.

Mₐₙₒᵣₘₐₗ=U^{N}ᵢMⁱₐₙₒᵣₘₐₗ

Next, similarly to the mask Mₐₙₒᵣₘₐₗ of the defect region, the region detection module 40D generates the mask Mₙₒᵣₘₐₗ of the normal region from the mask group [M¹ₙₒᵣₘₐₗ, M²ₙₒᵣₘₐₗ, . . . , M^{M}ₙₒᵣₘₐₗ] of the normal region.

Next, the region detection module 40D integrates the mask Mₐₙₒᵣₘₐₗ of the defect region and the mask Mₙₒᵣₘₐₗ Of the normal region to detect the defect region. As an example of a method of integrating the mask Mₐₙₒᵣₘₐₗ of the defect region and the mask Mₙₒᵣₘₐₗ of the normal region, a region where the mask Mₐₙₒᵣₘₐₗ of the defect region and the mask Mₙₒᵣₘₐₗ of the normal region overlap is removed from the mask Mₐₙₒᵣₘₐₗ of the defect region to generate a mask of the final defect region. Assuming that the mask of the final defect region is M^{out}ₐₙₒᵣₘₐₗ; it can be written as follows.

$${M}_{anormal}^{out} = {M}_{anormal} ⋀ ¬ {M}_{normal}$$

Finally, the region detection module 40D transmits the mask M^{out}ₐₙₒᵣₘₐₗ of the final defect region to the information output module 40E. In addition, it may be output from the region detection module 40D to the storage unit 42 once and held.

While there are few defects as learning data, there are many learning data on a road surface that is a normal region. Thus, the normal region can be accurately detected than the defect. The defect region can be more accurately detected by integrating the detection result of the defect region and the detection result of the normal region. Note that it is possible to detect only one of the defect region and the normal region.

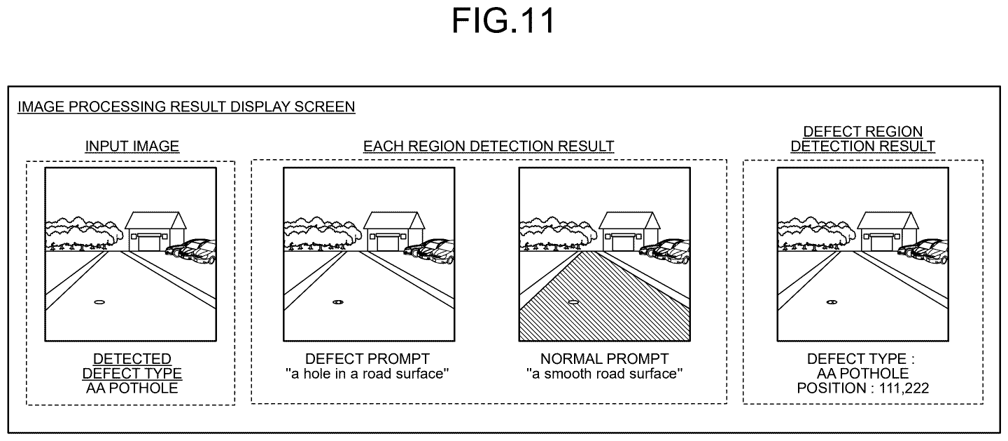

FIG. 11 illustrates an example of a detection result display screen according to the first embodiment. The information output module 40E outputs various types of information. For example, when defect of a road surface is detected by the detection module 40B, the information output module 40E outputs information related thereto.

For example, an image in which defect is detected and a detected defect type are displayed. In addition, the region detection result by the region detection module 40D may be displayed. The detected region may be superimposed and displayed on the input image. In addition, the region detection module 40D may display all the region detection results executed for each prompt. The attention information generation module 40C may display the generated prompt. In addition, the damage type, the damage level, the size, the area, and the position may be output. The photographed time and the photographed position of the image in which the defect is detected may be output. Furthermore, at least one of an image, detection information, attention information, and a result of region detection may be output.

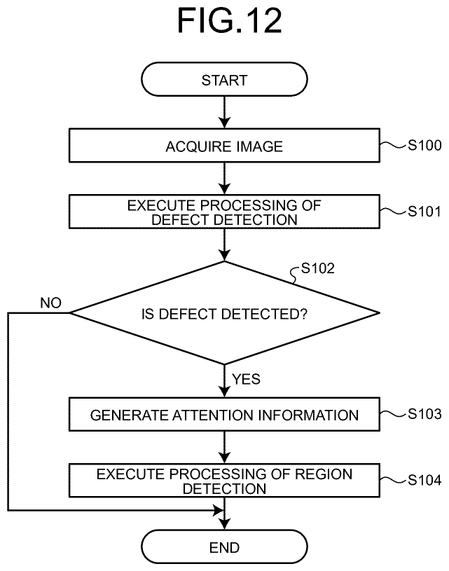

FIG. 12 is a flowchart illustrating an example of image processing executed by the image processing device 10 according to the first embodiment. First, the image acquisition module 40A acquires an imaged image related to a road surface of a road or the like from the imaging device 22 or the like. Then, the image acquisition module 40A sends the acquired imaged image to the detection module 40B (step S100).

Next, the detection module 40B executes defect detection processing using the first inference model on the imaged image acquired from the image acquisition module 40A, and acquires defect information such as a defect type (step S101).

Next, the detection module 40B determines whether defect of the detection target has been detected in the imaged image. When defect of the detection target is detected, the detection module 40B transmits defect information to the attention information generation module 40C. Furthermore, the image acquisition module 40A transmits the imaged image to the region detection module 40D (step S102).

Next, the attention information generation module 40C generates attention information such as text expressing defect or text expressing a surrounding normal region of the defect based on the acquired defect information such as the defect type. At this time, one of the text expressing the defect and the text expressing the surrounding normal region of the defect may be generated. The generated attention information is transmitted to the region detection module 40D (step S103).

Next, the region detection module 40D executes region detection processing using the imaged image acquired from the image acquisition module 40A and the attention information such as text generated by the attention information generation module 40C. Then, the region detection result is transmitted to the information output module 40E. Note that it may be output and held in the storage unit 42 once (step S104).

As a result, in the first embodiment, the attention information such as text of a defect region and a normal region related thereto is generated from the defect information such as a defect type obtained using a model learned by weakly supervised learning of the detection module 40B. Then, by performing region detection of defect and normality and integrating the respective region detection results, it is possible to accurately detect including the shape, coordinates, and the like of the defect region in the image.

That is, the information processing apparatus includes an attention information generation module 40C that generates attention information for performing region detection of a detection target based on detection information related to the detection target detected from an image using a first inference model that detects the detection target from the image, a region detection module 40D that performs region detection using a second inference model based on the attention information and the image from which the detection target is detected, and an information output module 40E that outputs at least one of the image, the detection information, the attention information, and a result of the region detection. Note that, although the output has been described, the output may be being held in the storage unit or being displayed.

### Second Embodiment

In the second embodiment, the detection module 40B outputs a likelihood map as defect information, and the attention information generation module 40C generates position information based on the likelihood map as the attention information. Then, an example in which the region detection module 40D executes region detection based on the position information will be described.

The second embodiment is different from the first embodiment in a detection module 40B, an attention information generation module 40C, a region detection module 40D, and an information output module 40E of the image processing unit 40. The other functional configuration blocks are the same as those of the first embodiment, and thus the description thereof will be omitted. Hereinafter, the detection module 40B, the attention information generation module 40C, the region detection module 40D, and the information output module 40E according to the second embodiment will be described.

The detection module 40B executes detection processing of a detection target on the imaged image acquired by the image acquisition module 40A. For example, the detection module 40B detects defect of a road surface with respect to the image of the road surface acquired by the image acquisition module 40A. When defect of a road surface is detected with respect to an image, defect information related to the defect is output. The detection module 40B outputs a likelihood map as defect information.

The likelihood map is a score map representing the defect likelihood at each position in the image. For example, the lengths of the vertical and horizontal directions of the likelihood map are the same as those of the input image. For example, the score takes a continuous value from 0 to 1, and the larger the value, the more likely the specific defect is. Which position in the input image is likely to have defect can be visualized by the likelihood map. In the second embodiment, an example in which a likelihood map is output as defect information will be described.

The likelihood map is obtained by calculating the score s_ij for all the regions in the image using the first inference model described in the first embodiment.

The attention information generation module 40C calculates the attention information for detecting the defect region based on the defect information of an image in which defect is detected.

In the first embodiment, the detection module 40B outputs the defect type as the defect information. In addition, the attention information generation module 40C generates, as the attention information, a text expressing a defect region and a text expressing a normal region based on the defect type.

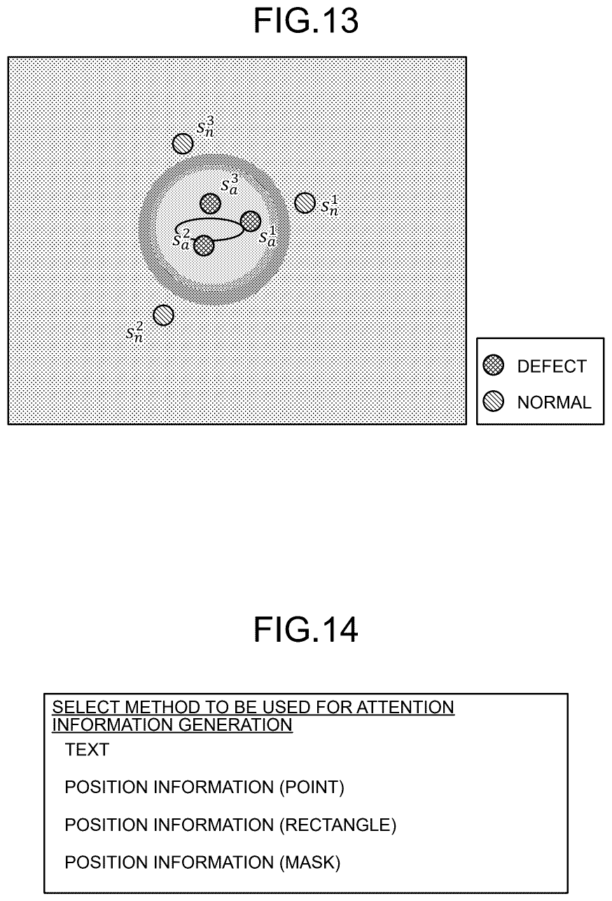

FIG. 13 illustrates an example of the likelihood map and the target point generated by the attention information generation module 40C according to the second embodiment. In the second embodiment, the attention information generation module 40C receives a likelihood map as defect information from the detection module 40B, and generates position information of a defect region and position information of a normal region based on the likelihood map.

For example, the attention information generation module 40C generates a target point and a rectangle as the position information. In the second embodiment, an example in which a target point is output as the position information will be described. The target point indicates a region (i, j) on the likelihood map. The attention information generation module 40C generates a set of target points Sₐₙₒᵣₘₐₗ indicating position information of the defect region.

Sₐₙₒᵣₘₐₗ has a target point indicating the position information of the defect region as an element. For example, if Sₐₙₒᵣₘₐₗ has N target points as elements, it can be written as Sₐₙₒᵣₘₐₗ=[s¹ₐ, s²ₐ, s³ₐ, . . . , s^{N}ₐ]. Here, sⁱₐ is one of the target points indicating the position information of the defect region. In addition, the attention information generation module 40C generates a set Sₙₒᵣₘₐₗ of target points indicating the position information of the normal region.

Sₙₒᵣₘₐₗ has a target point indicating the position information of the normal region as an element. For example, if Sₙₒᵣₘₐₗ has M target points as elements, it can be written as Sₙₒᵣₘₐₗ=[s¹ₙ, s²ₙ, s³ₙ, . . . , s^{M}ₙ]. Here, sⁱₙ is one of the target points indicating the position information of the normal region.

A method for generating Sₐₙₒᵣₘₐₗ by the attention information generation module 40C will be described with reference to FIG. 13. For example, the attention information generation module 40C sets a coordinate having the largest likelihood in the likelihood map as an element of Sₐₙₒᵣₘₐₗ as one target point. In addition, in a case where there is a plurality of coordinates having the largest likelihood, all the coordinates may be set as elements of Sₐₙₒᵣₘₐₗ as the target points. In addition, the user may designate the number of coordinates to select as the target point, and the element of Sₐₙₒᵣₘₐₗ may be set as the target point in descending order of likelihood until the designated number is reached. Furthermore, the number of coordinates designated by the user may be randomly selected from the coordinates having the likelihood greater than or equal to the threshold value designated by the user, and set as the element of Sₐₙₒᵣₘₐₗ as the target point. Moreover, a centroid point of coordinates having a likelihood greater than or equal to the threshold value designated by the user may be set as an element of Sₐₙₒᵣₘₐₗ as the target point.

Next, a method by which the attention information generation module 40C generates Sₙₒᵣₘₐₗ will be described. For example, the attention information generation module 40C outputs information of a region having a low likelihood as a target point indicating position information of a normal region related to a defect region. Since the likelihood is a score representing the defect likelihood, a region having a low likelihood is considered as a normal region. For example, as the target point of the normal region related to the defect region, coordinates having a low likelihood around a region having a high likelihood may be set as an element of Sₙₒᵣₘₐₗ as the target point. For example, the attention information generation module 40C may set a region of likelihood 0 in the closest vicinity of one element sⁱₐ of Sₐₙₒᵣₘₐₗ as the element of Sₙₒᵣₘₐₗ as the target point of the normal region. Furthermore, coordinates less than a threshold value existing in the vicinity of the coordinates having a likelihood greater than or equal to the threshold value designated by the user may be set as the element of Sₙₒᵣₘₐₗ as the target point of the normal region.

In FIG. 13, for example, a center ellipse surrounded by the target points s¹ₐ, s²ₐ, and s³ₐ indicates defect. The target points s¹ₐ, s²ₐ, and s³ₐ indicating the position information of the defect region are displayed around the defect. On the outer side thereof, the target points s¹ₙ, s²ₙ, and s³ₙ indicating the position information of the normal region are displayed.

In addition, the detection information includes a likelihood map indicating the likelihood of the detection target at each position of the image, and the attention information generation module 40C generates, as the attention information, position information of the defect region regarded as at least one detection target and position information of a normal region regarded as at least one background based on the likelihood map.

FIG. 14 illustrates an example of a selection screen for selecting a method to be used for attention information generation. The attention information used in the attention information generation module 40C may be selected from an input unit selectable by the user. In addition, the following (1) to (4) can be considered as the display related to the selection of the attention information.

(1) A target point or a rectangle can be selected as the attention information.

(2) The number of target points can be selected.

(3) There may be a UI in which a user sets a target point sampling method.

(4) There may be a UI in which a user manually sets a target point. That is, the position is selected while viewing the likelihood map.

Then, the attention information generation module 40C transmits the above-described Sₐₙₒᵣₘₐₗ and Sₙₒᵣₘₐₗ to the region detection module 40D as the attention information.

Next, the region detection module 40D detects the defect region based on the image in which the defect is detected by the detection module 40B and the attention information generated by the attention information generation module 40C.

When defect is detected by the detection module 40B, the region detection module 40D receives an image in which defect is detected from the image acquisition module 40A. Then, the detection of the defect region is performed on the image based on the attention information. The region detection module 40D performs region detection using the second inference model.

In the second embodiment, similarly to the first embodiment, a segment anything model (SAM) is used as the second inference model. A set of target points Sₐₙₒᵣₘₐₗ and Sₙₒᵣₘₐₗ generated as the attention information by the attention information generation module 40C is used as a prompt to input to the SAM. As described above, the Sₐₙₒᵣₘₐₗ generated by the attention information generation module 40C has the target point indicating the position information of the defect region as an element. Furthermore, Sₙₒᵣₘₐₗ has a target point indicating the position information of the normal region as an element.

The region detection module 40D performs detection of a normal region and detection of a defect region on the input image using sⁱₐ and sⁱₙ as prompts. For example, description will be made using the input image as x. Using the position information sⁱₐ of the defect region as a prompt, segmentation is performed on the input image x by the SAM. Then, assuming that the mask of the obtained defect region is Mⁱₐₙₒᵣₘₐₗ, it can be written as follows.

Mⁱₐₙₒᵣₘₐₗ=SAM(x,sⁱₐ)

Furthermore, for example, assuming that the mask of the normal region obtained by performing segmentation on the input image x by the SAM using the position information sⁱₙ of the normal region as a prompt is Mⁱₙₒᵣₘₐₗ, it can be written as follows.

Mⁱₙₒᵣₘₐₗ=SAM(x,sⁱₙ)

The region detection module 40D may perform region detection on all N elements of Sₐₙₒᵣₘₐₗ to generate a mask. Furthermore, the region detection module 40D may perform region detection on all M elements of Sₙₒᵣₘₐₗ to generate a mask. In addition, the SAM can receive a plurality of target points as one prompt and generate a mask. In this case, the mask may be generated with Sₐₙₒᵣₘₐₗ as a prompt. Specifically, the following equation is obtained.

Mₐₙₒᵣₘₐₗ=SAM(X,sₐₙₒᵣₘₐₗ)

The region detection module 40D integrates the mask of the defect region and the mask of the normal region to detect the defect region. Since the method of integrating masks is the same as that of the first embodiment, the description thereof will be omitted.

While there are few defects as learning data, there are many learning data on a road surface that is a normal region. Thus, the normal region can be accurately detected than the defect. The defect region can be more accurately detected by integrating the detection result of the defect region and the detection result of the normal region. Note that it may be either a defect region or a normal region. In addition, when a plurality of pieces of position information are generated by the attention information generation module 40C, the region detection module 40D may perform region detection over a plurality of times according to the number of pieces of generated position information.

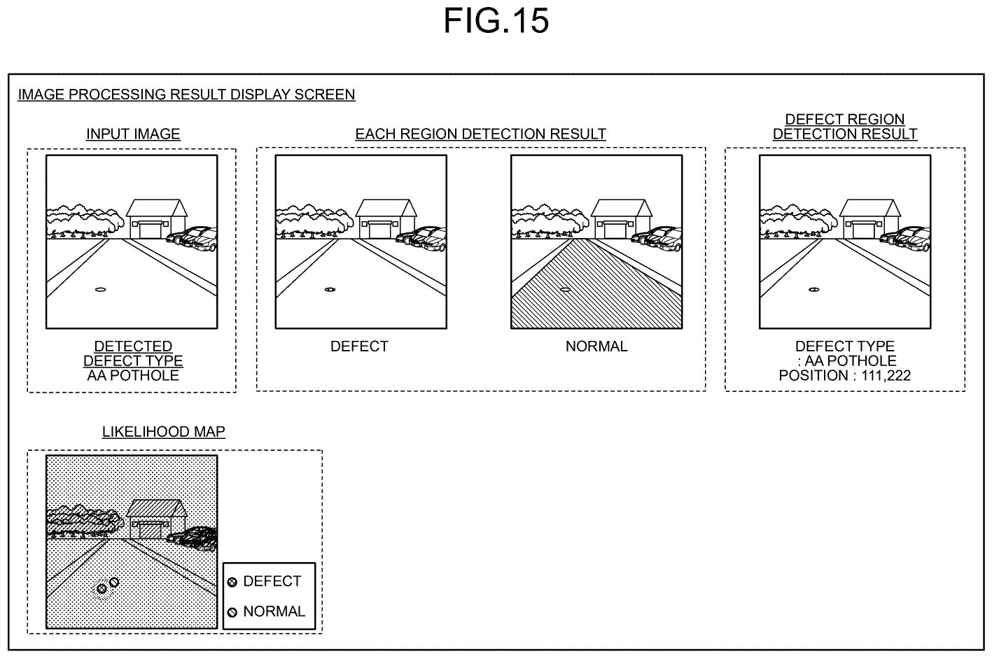

FIG. 15 illustrates an example of a display screen of a detection result in the second embodiment. The information output module 40E outputs various types of information similarly to the first embodiment. The information output module 40E displays the input image of the image acquisition module 40A, each region detection result of the detection module 40B, the likelihood map of the detection module 40B, and the defect region detection result of the region detection module 40D.

In the second embodiment, the attention information generation module 40C generates attention information of defect and a normal region related thereto from the likelihood map obtained by the detection module 40B using the model learned by the weakly supervised learning. Then, the region detection module 40D performs each region detection and integrates the respective region detection results. As a result, the shape, the position, and the type of the defect region in the image can be accurately detected.

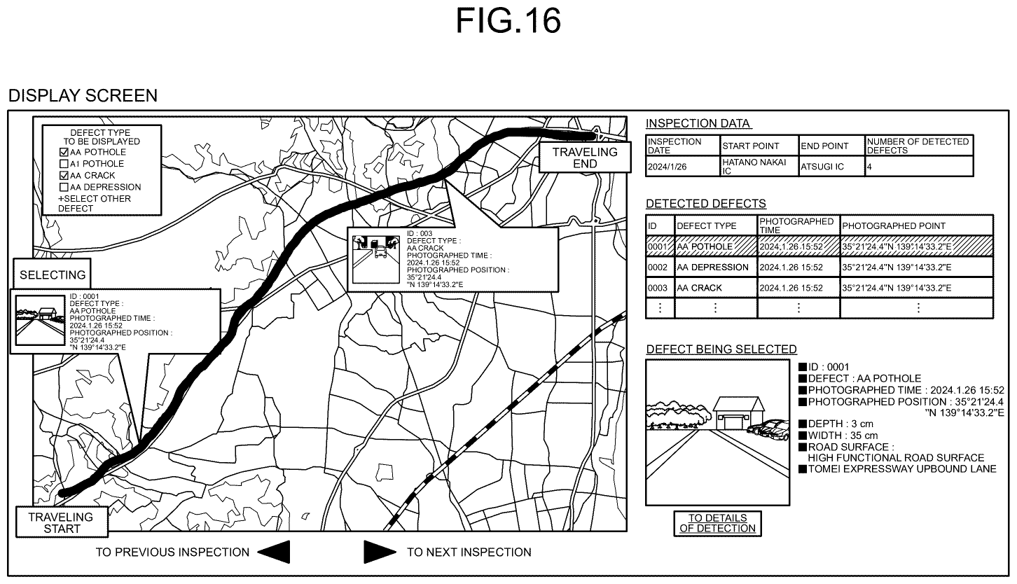

FIG. 16 is an example illustrating a display screen displaying at which point on the travel route an image at which defect has been detected has been imaged. For example, in FIG. 16, four defect detection points are illustrated on the travel route as the number of detected defects in the inspection data item in the upper right. Then, ID: 001 is selected. When selected, an image and detailed information of the defect are displayed in the defect item being selected in the lower right.

When “to details of detection” in the defect item being selected is selected, another window is opened and the screen can be transitioned to a display screen of details of detection such as enlarged display or a score map. In addition, the screen can transition to the detection result display screen illustrated in FIGS. 11 and 15. Note that in FIG. 16, the display is such that the inspection target is limited to a road surface, but the inspection target may be selected from a road surface, a guardrail, a sound insulation wall, and the like.

In the present embodiment, the road surface defect detection system 1 that detects a defect with an expressway as an inspection target and a road surface as a detection target has been described as an example. However, the inspection target and the detection target are not limited thereto. For example, the inspection object may include a general road, a bridge, a wind turbine blade, a steel tower, a solar panel, a power plant, and a substation. Furthermore, defect to be the detection target may include potholes, perforations, peeling, cracks, depressions, rust, falling objects, and rockfalls. Note that the inspection target is not limited to a road or the like, and may be an industrial product. According to this, quality inspection and the like before shipment can be performed.

In the present embodiment, an example in which image processing is executed on an image photographed by an imaging device mounted on a moving body has been described, but the present invention is not limited to this mode. For example, the image processing device may execute image processing on an image photographed manually or an image photographed by a fixed point camera.

In the present embodiment, the case of the defect region as the detection target and the normal region as the background region related to defect has been described, but the present invention is not limited to this mode.

As described above, an image processing program according to the present embodiment causes a computer to execute: an attention information generation procedure of generating, using a first inference model that detects a detection target from an image, attention information for performing region detection of a detection target based on detection information related to the detection target detected from the image, a region detection procedure of performing the region detection using a second inference model based on the attention information and the image from which the detection target is detected, and an information output procedure of outputting at least one of the image, the detection information, the attention information, and a result of the region detection.

Accordingly, by performing region detection of the detection target using the detection information and the attention information, the shape of the detection target in the image and the information on the detection target can be accurately detected from the attention information.

In addition, the attention information of the image processing program according to the present embodiment includes at least one of information related to the detection target and information of the background region related to the detection target, and the region detection procedure includes at least one of region detection of the detection target and detection of the background region.

As a result, the information related to the detection target can be detected by performing region detection from the information of the detection target or the information of the background region related to the detection target.

In addition, the region detection module of the image processing program according to the present embodiment performs the region detection by performing the region detection of the detection target and the detection of the background region and integrating the detection results.

Thus, the shapes of the detection target and the background region in the image and the information on the detection target can be more accurately detected by performing the region detection from the information on the detection target and the background region related to the detection target and integrating the respective detection results.

In addition, the detection information of the image processing program according to the present embodiment includes the type of the detection target, and the attention information generation procedure generates, as the attention information, a text prompt for characterizing at least one specific detection target and a text prompt for characterizing a background region related to the at least one specific detection target based on the type of the detection target.

As a result, shapes, types, and the like of the detection target and the background region in the image and the information related to the detection target can be accurately detected by generating a text prompt as information of a detection target and a background region related to the detection target, performing each region detection based on the text prompt, and integrating the detection results.

In addition, the detection information of the image processing program according to the present embodiment includes a likelihood map expressing the likelihood of the detection target at each position of the image, and the attention information generation procedure generates, as the attention information, position information of a region regarded as at least one detection target and position information of a region regarded as at least one background based on the likelihood map.

As a result, the shapes, the position information, and the like of the detection target and the background region in the image, the information of the likelihood map related to the detection target, and the like can be accurately detected by generating the position information as the information of the detection target and the background region related to the detection target, performing the respective region detections based on the position information, and integrating the detection results.

Furthermore, the first inference model of the image processing program according to the present embodiment learns from training data that has information about the presence or absence of a specific detection target in a predetermined unit with respect to an image, outputs a likelihood in a unit smaller than the predetermined unit, and performs learning such that the maximum value of the output likelihood matches the annotated label presence or absence of defect of the detection target.

As a result, the annotation work load of the training data of the first inference model can be reduced by using the machine learning model learned with the training data that has information about the presence or absence of the detection target.

In addition, the image processing program according to the present embodiment causes execution of an information output procedure of outputting at least one of an image, detection information, attention information, and a region detection result.

As a result, the user can easily grasp various types of information.

Furthermore, the attention information of the image processing program according to the present embodiment executes an input procedure that is selectable by the user.

As a result, the user can select appropriate attention information according to the detection target.

Furthermore, an image processing device according to the present embodiment includes an attention information generation module that generates, using a first inference model that detects a detection target from an image, attention information for performing region detection of a detection target based on detection information related to the detection target detected from the image, a region detection module that performs region detection using a second inference model based on the attention information and the image from which the detection target is detected, and an information output module that outputs at least one of an image, the detection information, the attention information, and a result of the region detection.

Furthermore, an image processing method according to the present embodiment includes generating, using a first inference model that detects a detection target from an image, attention information for performing region detection of a detection target based on detection information related to the detection target detected from the image, performs region detection using a second inference model based on the attention information and the image from which the detection target is detected, and outputting at least one of an image, the detection information, the attention information, and a result of the region detection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a memory; and
one or more processors coupled to the memory and configured to:
generate attention information for performing region detection of a detection target based on detection information related to the detection target, the detection target being detected from an image by using a first inference model;
perform the region detection by using a second inference model based on the attention information and the image from which the detection target is detected; and
output at least one of the image, the detection information, the attention information, and a result of the region detection.

2. The device according to claim 1, wherein
the attention information includes at least one of information related to the detection target and information of a background region related to the detection target, and
the one or more processors are configured to perform at least one of region detection of the detection target and detection of the background region.

3. The device according to claim 2, wherein
the one or more processors are configured to perform the region detection by performing the region detection of the detection target and the detection of the background region and integrating detection results.

4. The device according to claim 3, wherein
the detection information includes a type of the detection target, and
the one or more processors are configured to generate, as the attention information, a text prompt characterizing at least one specific detection target and a text prompt characterizing a background region related to the at least the one specific detection target based on the type of the detection target.

5. The device according to claim 3, wherein
the detection information includes a likelihood map indicating a likelihood of the detection target at each position of the image, and
the one or more processors are configured to generate, as the attention information, position information of at least one region regarded as the detection target and position information of at least one region regarded as a background based on the likelihood map.

6. The device according to claim 1, wherein
the first inference model learns with training data that has information about a presence or absence of a specific detection target in a predetermined unit with respect to the image, outputs a likelihood in a unit smaller than the predetermined unit, and
performs learning such that the maximum value of the output likelihood matches the annotated label presence or absence of defect of the detection target.

7. The device according to claim 1, wherein
the attention information executes an input procedure that is selectable by a user.

8. A computer program product comprising a computer-readable medium including programmed instructions, the instructions causing a computer to execute:
generating attention information for performing region detection of a detection target based on detection information related to the detection target, the detection target being detected from an image by using a first inference model;
performing the region detection by using a second inference model based on the attention information and the image from which the detection target is detected; and
outputting at least one of the image, the detection information, the attention information, and a result of the region detection.

9. An image processing method comprising:
generating attention information for performing region detection of a detection target based on detection information related to the detection target, the detection target being detected from an image by using a first inference model;
performing the region detection by using a second inference model based on the attention information and the image from which the detection target is detected; and
outputting at least one of the image, the detection information, the attention information, and a result of the region detection.
